(19) United States
(12) Patent Application Publication
(10) Pub. No.: US 2025/0233400 A1
(43) Pub. Date: Jul. 17, 2025

(54) IN-VEHICLE INTERRUPTING CURRENT SUPPLY DEVICE

(71) Applicants: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(72) Inventor: Kiyoshi AIZAWA, Yokkaichi-Shi, Mie (JP)

(73) Assignees: AutoNetworks Technologies, Ltd., Yokkaichi-Shi, Mie (JP); Sumitomo Wiring Systems, Ltd., Yokkaichi-Shi, Mie (JP); Sumitomo Electric Industries, Ltd., Osaka-Shi, Osaka (JP)

(21) Appl. No.: 18/854,747

(22) PCT Filed: Apr. 8, 2022
(86) PCT No.: PCT/JP2022/017348

§ 371 Date: Oct. 7, 2024

(51) Int. Cl. H02H 1/06; H02H 7/00

(52) U.S. Cl. CPC H02H 1/06; H02H 7/00

(57) ABSTRACT

An in-vehicle interrupting current supply device includes a transformer including a first winding portion and a second winding portion, a switching unit, a capacitor, a discharge circuit, and an inhibiting unit. The switching unit switches between an allowance state in which current conduction to the first winding portion is allowed and a cancellation state in which the allowance state is cancelled. The capacitor is electrically connected to an intermediate conductive path between the second winding portion and the breaker and can receive electric power from the second winding portion. The discharge circuit discharges the capacitor through a path different from the breaker. The capacitor is discharged through the path in response to the inhibiting unit switching to a permission state.

### CROSS-REFERENCE TO RELATED APPLICATIONS

This application is the U.S. national stage of PCT/JP2022/017348 filed on Apr. 8, 2022, the contents of which are incorporated herein.

### TECHNICAL FIELD

The present disclosure relates to an in-vehicle interrupting current supply device.

### BACKGROUND

JP S62-21322A discloses a driving circuit that uses a pulse transformer. The driving circuit disclosed in JP S62-21322A includes a power MOSFET that controls load electric power, a MOSFET that is provided in an upstream gate circuit of the power MOSFET, and a pulse transformer that inputs a PWM signal to the gate circuit.

There is an in-vehicle power supply system that includes a breaker that can interrupt an electric power path. In this type of power supply system, when an interrupting condition is established, a signal generation circuit provides an interruption signal to the breaker to cause the breaker to perform an interrupting operation.

However, a breaker provided in an electric power path may cause problems. For example, a surge voltage may be generated near the breaker during the interrupting operation, and a voltage caused by the surge voltage may enter the signal generation circuit side via a parasitic capacitance component, causing unexpected damage to elements. To address this problem, a configuration in which the signal generation circuit side and the breaker side are insulated from each other using a transformer or the like can be used, as disclosed in JP S62-21322A or the like.

However, a breaker that performs an interrupting operation upon receiving an input of a certain level of input current may require a large-sized component for insulating the signal generation circuit side and the breaker side from each other.

It is an object of the present disclosure to provide a technique that facilitates a reduction in size of an in-vehicle interrupting current supply device that can drive a breaker while improving the insulation between the driving unit side and the breaker side.

### SUMMARY

An in-vehicle interrupting current supply device according to an aspect of the present disclosure is an in-vehicle interrupting current supply device that is applied to an in-vehicle interrupting device including a breaker and a switch, the breaker being provided in an electric power path and including a current input portion that is insulated from the electric power path, and the in-vehicle interrupting device operating to allow current conduction to the current input portion in response to the switch performing an ON operation and thereby cause the breaker to perform an interrupting operation of interrupting the electric power path. The in-vehicle interrupting current supply device includes a transformer that includes a first winding portion and a second winding portion; a switching unit that switches between an allowance state in which current conduction to the first winding portion is allowed and a cancellation state in which the allowance state is cancelled; a capacitor that is electrically connected to an intermediate conductive path between the second winding portion and the breaker to receive electric power from the second winding portion, a discharge circuit that discharges the capacitor through a path that is different from the breaker; an inhibiting unit that switches between a permission state in which discharging of the capacitor by the discharge circuit is permitted, and an inhibition state in which discharging of the capacitor by the discharge circuit is inhibited; and a control unit that controls the switching unit and the inhibiting unit, wherein the control unit performs switching control such that the switching unit repeats alternate switching between the allowance state and the cancellation state, a charge current is supplied to the capacitor from the second winding portion side in response to the switching control being performed, a discharge current of the capacitor is supplied to the current input portion in response to the switch performing the ON operation, and the capacitor is discharged through the path in response to the inhibiting unit switching to the permission state.

### Advantageous Effects

A technique according to the present disclosure facilitates a reduction in size of an in-vehicle interrupting current supply device that can drive a breaker while improving the insulation between the driving unit side and the breaker side.

### BRIEF DESCRIPTION OF DRAWINGS

FIG. 1 is a block diagram schematically showing an example of an in-vehicle system that includes an in-vehicle interrupting current supply device according to a first embodiment.

FIG. 2 is a flowchart of processing performed by the in-vehicle interrupting current supply device.

FIG. 3 is a timing chart illustrating operations of an in-vehicle system according to a first embodiment.

FIG. 4 is a timing chart illustrating operations of an in-vehicle system according to a second embodiment.

### DETAILED DESCRIPTION OF PREFERRED EMBODIMENTS

Hereinafter, aspects of an embodiment according to the present disclosure will be listed and described.

In a first aspect, an in-vehicle interrupting current supply device is an in-vehicle interrupting current supply device that is applied to an in-vehicle interrupting device including a breaker and a switch, the breaker being provided in an electric power path and including a current input portion that is insulated from the electric power path, and the in-vehicle interrupting device operating to allow current conduction to the current input portion in response to the switch performing an ON operation and thereby cause the breaker to perform an interrupting operation of interrupting the electric power path. The in-vehicle interrupting current supply device includes a transformer that includes a first winding portion and a second winding portion; a switching unit that switches between an allowance state in which current conduction to the first winding portion is allowed and a cancellation state in which the allowance state is cancelled; a capacitor that is electrically connected to an intermediate conductive path between the second winding portion and the breaker to receive electric power from the second winding portion, a discharge circuit that discharges the capacitor through a path that is different from the breaker; an inhibiting unit that switches between a permission state in which discharging of the capacitor by the discharge circuit is permitted, and an inhibition state in which discharging of the capacitor by the discharge circuit is inhibited; and a control unit that controls the switching unit and the inhibiting unit, wherein the control unit performs switching control such that the switching unit repeats alternate switching between the allowance state and the cancellation state, a charge current is supplied to the capacitor from the second winding portion side in response to the switching control being performed, a discharge current of the capacitor is supplied to the current input portion in response to the switch performing the ON operation, and the capacitor is discharged through the path in response to the inhibiting unit switching to the permission state.

With the in-vehicle interrupting current supply device according to the first aspect, due to the presence of the transformer, the insulation between the driving unit (switching unit and control unit) side and the breaker side can be improved. Furthermore, the in-vehicle interrupting device not only inputs the electric current supplied directly from the second winding portion to the current input portion, but also inputs the discharge current from the capacitor to the current input portion. Accordingly, the in-vehicle interrupting device can achieve both a configuration in which the size of the transformer is suppressed and a configuration in which a certain level of electric current can be input to the current input portion, which facilitates a reduction in size of the in-vehicle interrupting current supply device that can drive the breaker while improving the insulation between the driving unit side and the breaker side. Moreover, with the in-vehicle interrupting current supply device, by switching the inhibiting unit to the permission state, the capacitor can be discharged through a path different from the breaker, and by switching the inhibiting unit to the inhibition state, discharging of the capacitor through the path can be suppressed.

In a second aspect, the in-vehicle interrupting current supply device according to the first aspect, wherein the current input portion includes a first terminal portion and a second terminal portion, the intermediate conductive path includes a first conductive path provided between one end of the second winding portion and the first terminal portion and a second conductive path provided between the other end of the second winding portion and the second terminal portion, one electrode of the capacitor is electrically connected to the first conductive path, and the other electrode of the capacitor is electrically connected to the second conductive path, the discharge circuit includes a resistor connected in parallel to the capacitor between the first conductive path and the second conductive path, and the inhibiting unit includes a second switch provided between the capacitor and the resistor, switches to the permission state in response to the second switch performing the ON operation, and switches to the inhibition state in response to the second switch performing an OFF operation.

With the in-vehicle interrupting current supply device according to the second aspect, a configuration in which the capacitor is discharged through a path different from the breaker can be easily realized.

In a third aspect, the in-vehicle interrupting current supply device according to the first or the second aspects, wherein the control unit, when, after starting the switching control, the charge voltage of the capacitor has exceeded a threshold voltage, stops the switching control, and switches the inhibiting unit to the inhibition state.

The in-vehicle interrupting current supply device according to the third aspect can suppress, after charging the capacitor to the threshold voltage, discharging of the capacitor, and can suppress the current consumption of a battery that supplies electric power to the first winding portion.

In a fourth aspect, the in-vehicle interrupting current supply device

according to any one of the first through the third aspects, wherein the control unit, when, after starting the switching control, the charge voltage of the capacitor has exceeded the threshold voltage, stops the switching control, and, when a predetermined restart condition has been established, restarts the switching control.

The in-vehicle interrupting current supply device according to the fourth aspect can suppress the case where the capacitor is left at a low charge voltage/alone with a low charge voltage.

In a fifth aspect, the in-vehicle interrupting current supply device according to the fourth aspect, wherein the control unit, when, after stopping the switching control, the charge voltage of the capacitor has decreased to less than or equal to/equal to or less than a second threshold voltage that is smaller than the threshold voltage, restarts the switching control.

The in-vehicle interrupting current supply device according to the fifth aspect can easily keep the charge voltage of the capacitor at the second threshold voltage or more.

In a sixth aspect, the in-vehicle interrupting current supply device according to the fourth aspect, wherein the control unit, when a predetermined standby time has elapsed after stopping the switching control, restarts the switching control.

The in-vehicle interrupting current supply device according to the sixth aspect can suppress the charge voltage of the capacitor from decreasing too low.

In a seventh aspect, the in-vehicle interrupting current supply device according to any one of the first through the sixth aspects, wherein the control unit performs first control in which the switching control is performed while keeping the inhibiting unit in the permission state.

The in-vehicle interrupting current supply device according to the seventh aspect can, when performing the first control, cause a current to flow to the discharge circuit in parallel to the charging of the capacitor, and therefore the stability of current at the time of charging can be improved.

In an eighth aspect, the in-vehicle interrupting current supply device according to any one of the first through the seventh aspects, wherein the control unit performs second control in which the switching control is performed while keeping the inhibiting unit in the inhibition state.

The in-vehicle interrupting current supply device according to the eighth aspect can, when performing the second control, charge the capacitor while inhibiting discharging through the discharge circuit, and therefore the time taken for the charge voltage of the capacitor to reach a target voltage can be easily shortened.

In a ninth aspect, the in-vehicle interrupting current supply device according to any one of the first through the eighth aspects, wherein the breaker is a pyrotechnic circuit breaker that interrupts the electric power path when a driving current flows into the current input portion.

The in-vehicle interrupting current supply device according to the ninth aspect can cause the pyrotechnic circuit breaker to perform an interrupting operation by supplying a driving current to the current input portion. In this type of pyrotechnic circuit breaker, a surge voltage is likely to be generated near the pyrotechnic circuit breaker due to the interrupting operation. However, in the interrupting current supply device, the surge voltage is unlikely to affect the driving unit side.

### First Embodiment

### Overview of In-Vehicle System 1

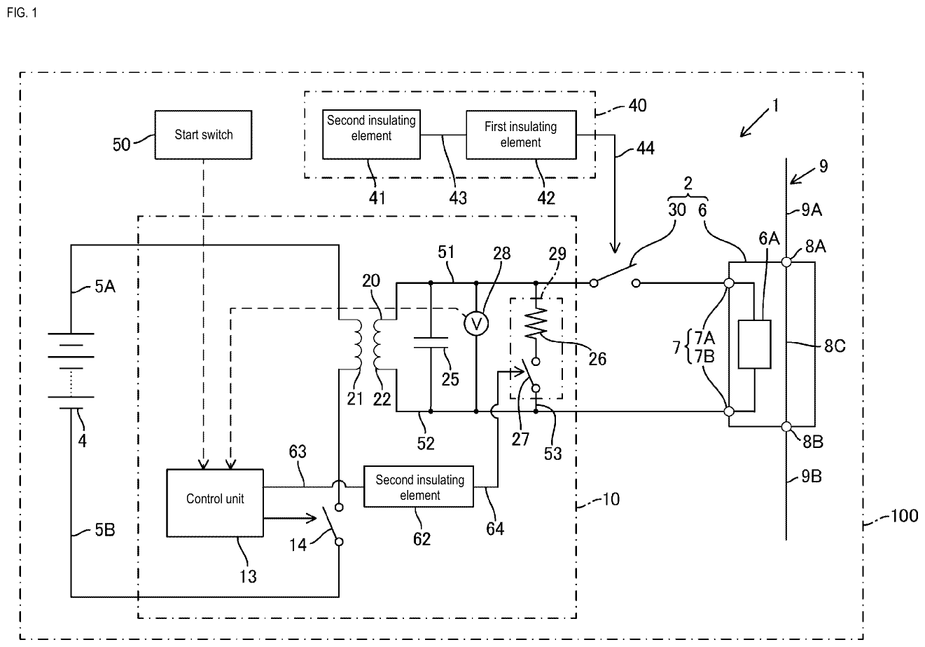

FIG. 1 shows an in-vehicle system 1 that includes an in-vehicle interrupting current supply device 10 according to a first embodiment. In the description given below, the in-vehicle interrupting current supply device 10 is also referred to as “interrupting current supply device 10”. The in-vehicle system 1 is a system that is mounted in a vehicle 100 and can supply electric power to various loads. The vehicle 100 in which the in-vehicle system 1 is mounted is a vehicle such as, for example, an electric vehicle, a plug-in hybrid car, or a hybrid car, or may be another type of vehicle.

As shown in FIG. 1, the in-vehicle system 1 is a system that is mounted in the vehicle 100. In FIG. 1, the vehicle 100 is conceptually indicated by a dashed-dotted line frame. The in-vehicle system 1 includes a battery 4, an interrupting current supply device 10, an interruption signal generation unit 40, an in-vehicle interrupting device 2, a start switch 50, and the like.

The start switch 50 may be, for example, an ignition switch for starting an engine in the case where the vehicle 100 is a plug-in hybrid car or a hybrid car. The start switch 50 may be a power switch for starting an EV system in the case where the vehicle 100 is an electric vehicle.

The battery 4 is an in-vehicle storage battery, and may be a secondary battery such as a lead acid battery or a lithium ion battery, or another type of storage battery. The battery 4 applies a predetermined DC voltage (for example, 12 V) between conductive paths 5A and 5B when it is fully charged. In the description given below, the output voltage of the battery 4 is indicated by V1.

An electric power path 9 is a conductive path through which electric power is transmitted. The electric power path 9 can be used as, for example, a conductive path for supplying electric power to the loads mounted in the vehicle. However, the application of the electric power path 9 is not limited thereto. The electric power path 9 includes a first electric power path 9A that is connected to one side of a breaker 6 and a second electric power path 9B that is connected to the other side of the breaker 6. The first electric power path 9A and the second electric power path 9B are directly connected to each other when the breaker 6 is in a conducting state, and are insulated from each other when the breaker 6 is in a cut-off state. In FIG. 1, elements that are connected to the first electric power path 9A and the second electric power path 9B on the opposite side of the breaker 6 are not shown. The electric power path 9 is, for example, a conductive path to which a voltage higher than the voltage applied between the conductive paths 5A and 5B is applied.

The in-vehicle interrupting device 2 is a device for interrupting the electric power path 9. The in-vehicle interrupting device 2 includes a switch 30 and the breaker 6.

The switch 30 is constituted by a semiconductor switch such as an FET (Field Effect Transistor), a mechanical relay, or the like. The switch 30 allows an electric current to flow from capacitor 25 side to first terminal portion 7A side when the switch 30 is ON, and interrupts the electric current flowing from the capacitor 25 side to the first terminal portion 7A side when the switch 30 is OFF. Specifically, the switch 30 is ON while the interruption signal generation unit 40 is outputting an interruption signal (ON signal), and is OFF while the interruption signal generation unit 40 is outputting an interruption end signal (OFF signal). The bidirectional current conduction via the switch 30 is interrupted when the switch 30 is OFF, and is allowed when the switch 30 is ON.

In the example shown in FIG. 1, the breaker 6 is constituted by a pyrotechnic circuit breaker. As the pyrotechnic circuit breaker, a known pyrotechnic fuse such as Pyro-Fuse (registered trademark) can be preferably used. The breaker 6 includes a current input portion 7, conductor portions 8A, 8B, and 8C, an igniter 6A, and a displacement portion (not shown). The current input portion 7 includes a first terminal portion 7A and a second terminal portion 7B, and is a portion through which an electric current flowing from the first terminal portion 7A toward the second terminal portion 7B flows when the switch 30 is ON. The current input portion 7 is insulated from the electric power path 9. The conductor portion 8A is a terminal that is connected to the first electric power path 9A and directly connected to the first electric power path 9A. The conductor portion 8B is a terminal that is connected to the second electric power path 9B and directly connected to the second electric power path 9B. The conductor portion 8C is a conductor that is directly connected between the conductor portion 8A and the conductor portion 8B.

The igniter 6A is a portion that functions to cause a small explosion when an electric current flows from the first terminal portion 7A toward the second terminal portion 7B to move the displacement portion by the explosion. The displacement portion is held at a predetermined position before the explosion is caused by the igniter 6A (in a state in which the conductor portions 8A, 8B, and 8C are directly connected to each other), and, when the explosion is caused by the igniter 6A, functions to disconnect and interrupt the conductor portion 8C by being displaced toward the conductor portion 8C side by the explosion.

As described above, in the in-vehicle interrupting device 2, when the switch 30 is switched to an ON state to allow current conduction to the current input portion 7, and a driving current flows through the current input portion 7 (specifically, when the driving current flows into the second terminal portion 7B from the first terminal portion 7A via the igniter), the breaker 6 operates to interrupt the electric power path 9.

The interruption signal generation unit 40 includes a signal generating device 41 and a first insulating element 42. The signal generating device 41 is a device that can perform an operation of providing an interruption signal (ON signal) to the switch 30 via a conductive path 44 and an operation of providing an interruption end signal (OFF signal) to the switch 30 via the conductive path 44.

The signal generating device 41 is connected to a conductive path 43, and can provide an interruption signal (ON signal) and an interruption end signal (OFF signal) to the conductive path 43. One of the interruption signal and the interruption end signal is a high-level signal, and the other thereof is a low-level signal. The first insulating element 42 is an element that transmits a signal applied through the conductive path 43 to the conductive path 44 while insulating the conductive path 43 and the conductive path 44 from each other. The insulation method used in the first insulating element 42 may be an optical insulation method, an inductive insulation method, or a capacitive insulation method. In any case, when an interruption signal (ON signal) is output from the signal generating device 41 to the conductive path 43, the interruption signal (ON signal) is applied to the switch 30 while the signal generating device 41 and the switch 30 are insulated from each other, and in response thereto, the switch 30 performs an ON operation.

The signal generating device 41 outputs the interruption signal (ON signal) when a predetermined condition for interrupting the electric power path 9 is established. For example, the signal generating device 41 operates to output the interruption end signal (OFF signal) in a normal state in which the value of electric current flowing through the electric power path 9 is less than or equal to a threshold value, and output the interruption signal (ON signal) in an overcurrent state in which the value of electric current flowing through the electric power path 9 exceeds the threshold value. The predetermined condition for interrupting the electric power path 9 is not limited to the example described above, and the signal generating device 41 may operate to output the interruption signal (ON signal) when the vehicle 100 crashes.

### Configuration of Interrupting Current Supply Device 10

The interrupting current supply device 10 includes a control unit 13, a switching switch 14, a transformer 20, a capacitor 25, a resistor 26, a second switch 27, a voltage detecting unit 28, and a second insulating element 62. The resistor 26 and second switch 27 constitute a series configuration unit 29. The series configuration unit 29 has a configuration in which the resistor 26 and second switch 27 are connected in series to each other. The interrupting current supply device 10 is a portion that functions as a supply source for causing a driving current to flow to the breaker 6.

The control unit 13 includes a control device. The control device is an information processing device that has a computation function and an information processing function, and includes, for example, a CPU, a storage unit, and the like. The control unit 13 outputs an ON signal for causing the switching switch 14 to perform an ON operation and an OFF signal for causing the switching switch 14 to perform an OFF operation. One of the ON signal and the OFF signal is, for example, a high-level signal, and the other thereof is a low-level signal.

The switching switch 14 corresponds to an example of a switching unit. As a result of entering an ON state, the switching switch 14 enters an allowance state in which a current is allowed to flow to the first winding portion 21. As a result of entering an OFF state, the switching switch 14 enters a cancellation state in which the allowance state is cancelled. That is, the switching switch 14 switches between the allowance state in which a current is allowed to flow to the first winding portion 21 and the cancellation state in which the allowance state is cancelled. The switching switch 14 is constituted by a switching element, for example, and is specifically constituted by a semiconductor switching element such as an FET (Field Effect Transistor). The switching switch 14 performs an ON operation when an ON signal is applied from the control unit 13, and switches to the allowance state. The switching switch 14 performs an OFF operation when an OFF signal is applied from the control unit 13, and switches to a cancellation state. Note that the switching switch 14 may also be a switching element (e.g., a bipolar transistor or the like) other than the FET.

The transformer 20 is a transformer that includes a first winding portion 21 and a second winding portion 22. The first winding portion 21 and the second winding portion 22 are constituted by coils. When the electric current in the first winding portion 21 varies, the transformer 20 causes the second winding portion 22 to generate a voltage that corresponds to the variation in the electric current in the first winding portion 21. The number of windings N1 of the first winding portion 21 may be greater or less than the number of windings N2 of the winding portion of the second winding portion 22. When the switching switch 14 is an allowance state, an input voltage Vin that is equivalent to the output voltage of the battery 4 is applied across the first winding portion 21. When the voltage across the second winding portion 22 is denoted as output voltage Vout,? Vin/Vout=N1/N2. That is, an output voltage represented by Vout=Vin×N2/N1 is generated in the second winding portion 22 in response to the switching switch 14 being switched from a cancellation state to an allowance state.

A first conductive path 51 is a conductive path that is provided between one end of the second winding portion 22 and the first terminal portion 7A. A second conductive path 52 is a conductive path that is provided between the other end of the second winding portion 22 and the second terminal portion 7B. The second conductive path 52 is a conductor portion that is directly connected to another end of the second winding portion 22, another electrode of the capacitor 25, another end of the series configuration unit 29, and the second terminal portion 7B. A portion of the first conductive path 51 on the second winding portion 22 side relative to the switch 30 is directly connected to one end of the second winding portion 22, one electrode of the capacitor 25, and one end of the series configuration unit 29. A portion of the first conductive path 51 on the breaker 6 side relative to the switch 30 is directly connected to the first terminal portion 7A.

The capacitor 25 is an element that is electrically connected to the first conductive path 51 and the second conductive path 52 which are intermediate conductive paths between the second winding portion 22 and the breaker 6, and receives electric power from the second winding portion 22. One electrode of the capacitor 25 is electrically connected to the first conductive path 51, and the other electrode is electrically connected to the second conductive path 52. When the switch 30 is ON, an electric current can flow from the capacitor 25 to the first terminal portion 7A via the first conductive path 51.

The third conductive path 53 corresponds to an example of a “path different from the breaker”. Between the first conductive path 51 and the second conductive path 52, the third conductive path 53 is connected in parallel to the capacitor 25, and is also connected in parallel to the breaker 6. One end of the third conductive path 53 is directly connected to the first conductive path 51, and the other end of the third conductive path 53 is directly connected to the second conductive path 52.

The resistor 26 corresponds to an example of a discharge circuit. The resistor 26 has a function of discharging the capacitor 25. The resistor 26 is connected in parallel to the capacitor 25, and is also connected in parallel to the breaker 6, between the first conductive path 51 and the second conductive path 52. The resistor 26 is provided on the third conductive path 53.

The second switch 27 corresponds to an example of an inhibiting unit. As a result of entering an ON state, the second switch 27 enters a permission state in which discharging of the capacitor 25 through the resistor 26 is permitted. As a result of entering an OFF state, the second switch 27 enters an inhibition state in which discharging of the capacitor 25 through the resistor 26 is inhibited. That is, the second switch 27 switches between the permission state in which discharging of the capacitor 25 through the resistor 26 is permitted and the inhibition state in which discharging of the capacitor 25 through the resistor 26 is inhibited. The second switch 27 is constituted by a switching element, for example, and is specifically constituted by a semiconductor switch element such as an FET (Field Effect Transistor). The second switch 27 performs an ON operation when an ON signal is applied from the control unit 13, and switches to the permission state. The second switch 27 performs an OFF operation when an OFF signal is applied from the control unit 13, and switches to the inhibition state. Note that the second switch 27 may also be a switching element (e.g., a bipolar transistor or the like) other than a FET. The second switch 27 is provided on the third conductive path 53. That is the aforementioned series configuration unit 29 is provided on the third conductive path 53.

The second insulating element 62 is provided between the second switch 27 and the control unit 13, and insulates the control unit 13 and second switch 27 from each other. The control unit 13 may perform an operation to apply a permission signal (ON signal) to the second switch 27 through the conductive path 64, and an operation to apply an inhibition signal (OFF signal) to the second switch 27 through the conductive path 64. The control unit 13 is electrically connected to the conductive path 63, and may apply a permission signal (ON signal) and an inhibition signal (OFF signal) to the conductive path 63. One of the permission signal and the inhibition signal is a high-level signal, and the other thereof is a low-level signal. The second insulating element 62 is an element that transmits a signal provided through the conductive path 63 to the conductive path 64 while insulating the conductive path 63 and the conductive path 64 from each other. The insulation method used in the second insulating element 62 may be an optical insulation method, an inductive insulation method, or a capacitive insulation method. In any case, when a permission signal (ON signal) is output from the control unit 13 to the conductive path 63, the permission signal (ON signal) is applied to the second switch 27 while the control unit 13 and the second switch 27 are insulated from each other, and in response thereto, the second switch 27 performs an ON operation.

The voltage detecting unit 28 has a function of detecting the charge voltage of the capacitor 25. The voltage detecting unit 28 is configured as a known voltage detection circuit, for example. The voltage detecting unit 28 detects the voltage between the first conductive path 51 and the second conductive path 52. The voltage detecting unit 28 may or may not divide the voltage to be detected. The voltage detecting unit 28 output a signal with which the detection value can be specified to the control unit 13.

### Operations of Interrupting Current Supply Device 10

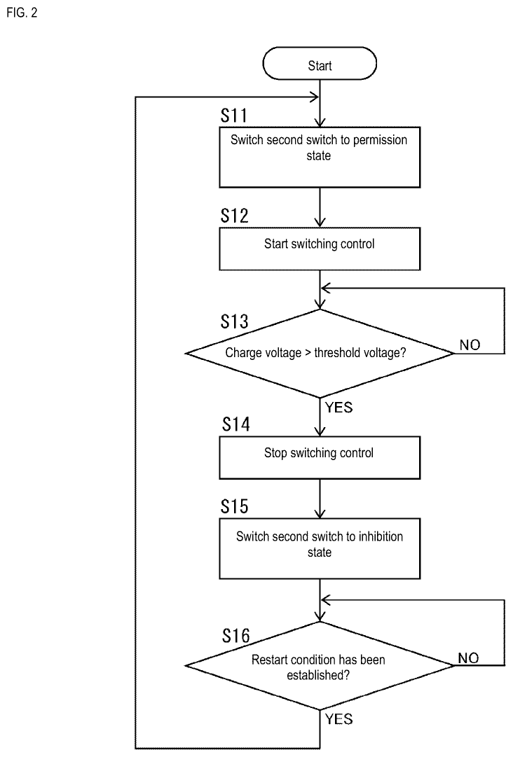

In a normal state, the switch 30 is kept in an OFF state, and a driving current is not supplied to the current input portion 7 of the breaker 6. When a predetermined start condition has been established, the control unit 13 of the interrupting current supply device 10 performs the processing illustrated in FIG. 2. The start condition is switching of the start switch 50 for starting the vehicle 100 from an OFF state to an ON state, for example. When the start condition has been established, the control unit 13, in step S11, switches the second switch 27 from an OFF state (inhibition state) to an ON state (permission state), and in step S12, starts the aforementioned switching control. At a point in time at which the switching control is started, the control unit 13 performs first control in which the switching control is performed while the second switch 27 is kept in an allowing state.

In the switching control, the control unit 13 applies an ON/OFF signal that alternately repeats an ON signal and an OFF signal to the switching switch 14. Specifically, the control unit 13 switches the switching switch 14 between on and off by providing a PWM signal that includes a high-level signal as the ON signal and a low-level signal as the OFF signal to the switching switch 14. In response to the switching switch 14 being switched from an OFF state (cancellation state) to an ON state (allowance state), an input voltage Vin that corresponds to the output voltage of the battery 4 is applied across the first winding portion 21. In response to the switching switch 14 being switched from an ON state (allowance state) to an OFF state (cancellation state), the application of the voltage from the battery 4 across the first winding portion 21 is cancelled. With the ON/OFF operation described above, switching is alternately performed between a state in which the output voltage V1 is applied across the first winding portion 21 and a state in which the application of the output voltage V1 across the first winding portion 21 is cancelled. In response to the ON/OFF operation, in the second winding portion 22, an output voltage of about V1×N2/N1 is generated at maximum. As described above, in response to the control unit 13 repeating alternate switching between an ON state (allowance state) and an OFF state (cancellation state), a charge current is supplied from the second winding portion 22 side to the capacitor 25. Also, since the second switch 27 is in an ON state (permission state), a small amount of electric current can flow into the resistor 26.

When the switch 30 is switched from an OFF state to an ON state while the capacitor 25 is being charged, in response to the switch 30 performing an ON operation, the capacitor 25 is discharged, and a driving current flows into the current input portion 7. For example, when the switch 30 is switched from an OFF state to an ON state while the control unit 13 is performing the switching control, in a state in which an electric current that corresponds to the operation of the switching switch 14 is supplied from the second winding portion 22 to the first conductive path 51, an electric current is discharged from the capacitor 25 to the current input portion 7. As described above, when the driving current is supplied from the capacitor 25 to the current input portion 7, a small explosion is caused in the igniter 6A, and the breaker 6 interrupts the electric power path 9.

In the present embodiment, it is desirable that a maximum value of the driving current supplied to the current input portion 7 in response to the switch 30 performing the ON operation is greater than a maximum value of the charge current supplied to the capacitor 25 during charging of the capacitor 25. The control unit 13 applies the PWM signal to the switching switch 14 while adjusting the duty ratio to satisfy the relationship.

After starting the switching control (specifically, first control), in step S13, the control unit 13 determines whether the charge voltage of the capacitor 25 has exceeded a threshold voltage Vth1. The threshold voltage Vth1 is larger than 0 V, and is larger than a minimum value of the voltage needed to drive the breaker 6 (hereinafter, may also be referred to as a “driving voltage of the breaker 6”).

Upon determining that the charge voltage of the capacitor 25 has not exceeded the threshold voltage Vth1 (NO in step S13), the control unit 13 returns the processing to step S13. That is, the control unit 13 continues the switching control (specifically, first control) until the charge voltage of the capacitor 25 exceeds the threshold voltage Vth1. Accordingly, a charge current continues to be supplied to the capacitor 25.

Upon determining that the charge voltage of the capacitor 25 has exceeded the threshold voltage Vth1 (YES in step S13), in step S14, the control unit 13 stops the switching control, and in step S15, switches the second switch 27 to the inhibition state. That is, the control unit 13 stops the first control. Accordingly, the supply of a charge current to the capacitor 25 stops, and discharging of the capacitor 25 to the resistor 26 is also inhibited.

As a result of the control unit 13 stopping the switching control, the switching switch 14 enters an OFF state (cancellation state). When the switch 30 is switched from an OFF state to an ON state while the switching switch 14 maintains an OFF state (cancellation state), a current is discharged from the capacitor 25 to the current input portion 7. In this case, a small explosion is caused in the igniter 6A, and the breaker 6 interrupts the electric power path 9 as long as the capacitor 25 is sufficiently charged before discharging, and an electric current is sufficiently supplied to the current input portion 7.

Incidentally, even when the second switch 27 is in an OFF state (inhibition state), the charge voltage of the capacitor 25 may decrease. A leak current that occurs between drain and source of the second switch 27 or the like is envisioned as the cause thereof, for example. Therefore, after stopping the first control, in step S16, the control unit 13 determines whether or not a predetermined restart condition has been established.

For example, the restart condition is that the charge voltage of the capacitor 25 has decreased to a second threshold voltage Vth2 or less. The second threshold voltage Vth2 is smaller than the threshold voltage Vth1. The second threshold voltage Vth2 is larger than 0 V, and is larger than a minimum value of the driving voltage of the breaker 6.

Upon determining that the restart condition has not been established (NO in step S16), the control unit 13 returns the processing to step S16. That is, the control unit 13 stops the switching control and keeps the state in which the second switch 27 is in an OFF state (inhibition state) until the restart condition is established.

Upon determining that the restart condition has been established (YES in step S16), the control unit 13 returns the processing to step S11. That is, after charging the capacitor 25 until the charge voltage thereof exceeds the threshold voltage Vth1, if the charge voltage of the capacitor 25 decreases to the second threshold voltage Vth2 or less, the control unit 13 performs the switching control (specifically, first control) so as to increase the charge voltage of the capacitor 25 to the threshold voltage Vth1 or more.

Upon a predetermined termination condition having been established, the control unit 13 ends the processing shown in FIG. 2, switches the second switch 27 to an ON state (permission state) so as to discharge the capacitor 25. The termination condition is that the start switch 50 for starting the vehicle 100 is switched from an ON state to an OFF state, for example. After discharging the capacitor 25, the control unit 13 returns the second switch 27 to an OFF state (inhibition state). The timing at which the second switch 27 is returned to an OFF state may be a timing at which the charge voltage of the capacitor 25 has decreased to 0 V, or may also be a timing at which a predetermined discharge time has elapsed after starting discharging.

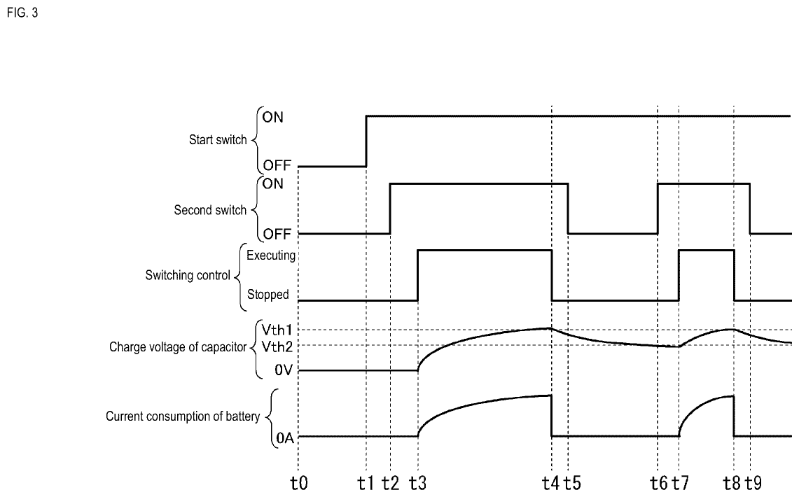

The following description relates to a specific example of the operations of the interrupting current supply device 10. At timing to shown in FIG. 3, the start switch 50 is in an OFF state, the second switch 27 is in an OFF state (inhibition state), the switching control is not being performed, the charge voltage of the capacitor 25 is 0 V, and the current consumption of the battery 4 is 0 A. Thereafter, at timing t1, upon the start switch 50 entering an ON state, the start condition is established. Then, at timing t2, the second switch 27 is switched to an ON state (permission state), and at timing t3, the switching control is started. Upon the switching control being started, the charge voltage of the capacitor 25 gradually increases. Also, following the increase in the charge voltage of the capacitor 25, the current consumption of the battery 4 gradually increases. At timing t4, upon the charge voltage of the capacitor 25 having exceeded the threshold voltage Vth1, the switching control is stopped, and the current consumption of the battery 4 decreases to 0 A. Also, at timing t5, the second switch 27 is switched to an OFF state (inhibition state).

After the switching control is stopped, the charge voltage of the capacitor 25 gradually decreases. At timing t6, upon the charge voltage of the capacitor 25 having decreased to the second threshold voltage Vth2 or less, the restart condition is established, and the second switch 27 is switched to an ON state (permission state). Also, at timing t7, the switching control is started. Accordingly, the charge voltage of the capacitor 25 increases again, and the current consumption of the battery 4 increases. Thereafter, at timing t8, upon the charge voltage of the capacitor 25 having exceeded the threshold voltage Vth1, the switching control is stopped, and the current consumption of the battery 4 decreases to 0 A. Also, at timing t9, the second switch 27 is switched to an OFF state (inhibition state). As a result of the switching control being performed intermittently as described above, the current consumption of the battery 4 is suppressed, and the charge voltage of the capacitor 25 is easily kept at the second threshold voltage Vth2 or more.

### Examples of Advantageous Effects

With the interrupting current supply device 10, due to the presence of the transformer 20, the insulation between the driving unit (control unit 13 and switching switch 14) side and the breaker 6 side can be improved. Furthermore, the in-vehicle interrupting device 2 not only inputs the electric current supplied directly from the second winding portion 22 to the current input portion 7, but also inputs the discharge current from the capacitor 25 to the current input portion 7. Accordingly, the in-vehicle interrupting device 2 can achieve both a configuration in which the size of the transformer 20 is suppressed and a configuration in which a certain level of electric current can be input to the current input portion 7, which facilitates a reduction in size of the in-vehicle interrupting current supply device 10 that can drive the breaker 6 while improving the insulation between the switching switch 14 side and the breaker 6 side.

The interrupting current supply device 10 can supply a charge current to the capacitor 25 from the second winding portion 22 via the first conductive path 51 during a driving operation in which the switching switch 14 repeats alternate switching between an ON state (allowance state) and an OFF state (cancellation state). When the switch 30 is switched from an OFF state to an ON state, the interrupting current supply device 10 can cause an electric current to flow from the capacitor 25 to the first terminal portion 7A through the first conductive path 51, and cause the breaker 6 to perform an interrupting operation.

After charging the capacitor 25 to the threshold voltage Vth1, the interrupting current supply device 10 can suppress discharging of the capacitor 25, and can suppress the current consumption due to operating the switching switch 14.

The interrupting current supply device 10 can suppress the case where the capacitor 25 is left at a low charge voltage. The interrupting current supply device 10 easily keeps the charge voltage of the capacitor 25 at the second threshold voltage Vth2 or more.

By performing the first control, the interrupting current supply device 10

can cause a current to flow to the resistor 26 in parallel to the charging of the capacitor 25, and therefore the stability of current at the time of charging can be improved.

In a state in which the switching switch 14 repeats alternate switching between an ON state (allowance state) and an OFF state (cancellation state), in addition to the discharge operation from the capacitor 25, an electric current based on the second winding portion 22 can also be used together.

The interrupting current supply device 10 can cause the pyrotechnic circuit breaker (the breaker 6) to perform an interrupting operation by supplying the driving current to the current input portion 7. In this type of pyrotechnic circuit breaker, a surge voltage is likely to be generated near the pyrotechnic circuit breaker due to the interrupting operation. However, in the interrupting current supply device 10, the surge voltage is unlikely to affect the driving unit (control unit 13 and switching switch 14) side.

### Second Embodiment

The restart condition (refer to step S16 in FIG. 2) is not limited to the configuration described in the first embodiment. In the second embodiment, another example of the restart condition will be described. Note that the configuration of the second embodiment is the same as that of the first embodiment except for the restart condition.

The restart condition of the second embodiment is that a predetermined standby time T has elapsed since the switching control was stopped in step S14 in FIG. 2. The standby time T is set such that the charge voltage of the capacitor 25 will not decrease below a minimum value of the driving voltage of the breaker 6. The standby time T is determined based on the capacitance of the capacitor 25, the minimum value of the driving voltage of the breaker 6, and the leak current of the second switch 27 between drain and source when the second switch 27 is in an OFF state (inhibition state), for example.

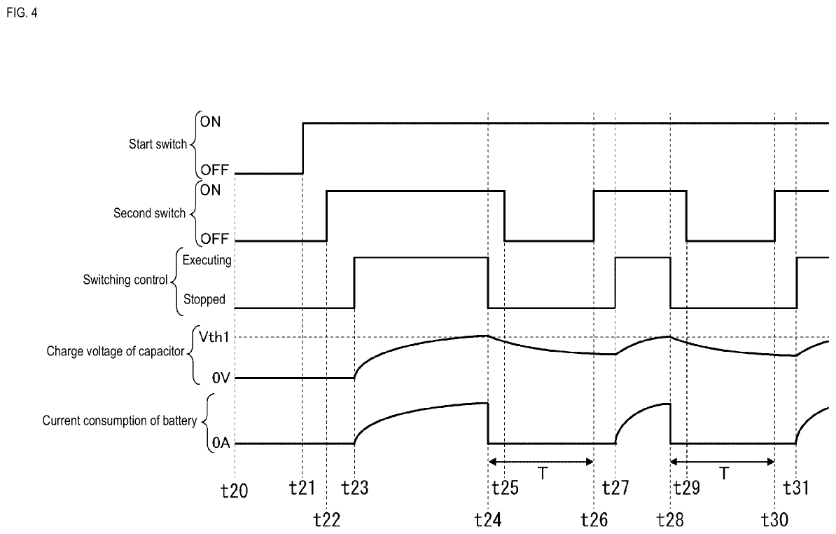

The following description relates to a specific example of the operations of the interrupting current supply device 10 of the second embodiment. At timing t20 shown in FIG. 4, the start switch 50 is in an OFF state, the second switch 27 is in an OFF state (inhibition state), the switching control is not being performed, the charge voltage of the capacitor 25 is 0 V, and the current consumption of the battery 4 is 0 A. Thereafter, at timing t21, upon the start switch 50 entering an ON state, the start condition is established. Also, at timing t22, the second switch 27 is switched to an ON state (permission state), and at timing t23, the switching control is started. Upon the switching control being started, the charge voltage of the capacitor 25 gradually increases. Also, following the increase in the charge voltage of the capacitor 25, the current consumption of the battery 4 gradually increases. At timing t24, upon the charge voltage of the capacitor 25 exceeding the threshold voltage Vth1, the switching control is stopped, and the current consumption of the battery 4 decreases to 0 A. Also, at timing t25, the second switch 27 is switched to an OFF state (inhibition state).

After the switching control is stopped, the charge voltage of the capacitor 25 gradually decreases. When the elapsed time since the switching control was stopped has exceeded the standby time T at timing t26, the restart condition is established, and the second switch 27 is switched to an ON state (permission state). Also, at timing t27, the switching control is started. Accordingly, the charge voltage of the capacitor 25 increases again, and the current consumption of the battery 4 increases. Thereafter, at timing t28, upon the charge voltage of the capacitor 25 exceeding the threshold voltage Vth1, the switching control is stopped, and the current consumption of the battery 4 decreases to 0 A. Also, at timing t29, the second switch 27 is switched to an OFF state (inhibition state). At timing t30, upon the elapsed time since the switching control was stopped exceeding the standby time T, the restart condition is established, and the second switch 27 is switched to an ON state (permission state). Also, at timing t31, the switching control is started. As a result of intermittently performing the switching control, the current consumption of the battery 4 is suppressed, and the charge voltage of the capacitor 25 is easily kept at the minimum value of the driving voltage of the breaker 6 or more.

### Other Embodiments

The present disclosure is not limited to the embodiments described in the foregoing description and drawings. For example, the features described in the embodiments given above and embodiments given below may be combined as appropriate unless they are contradictory to each other. Also, any of the features described in the embodiments given above and the embodiments given below may be omitted unless it is clearly stated that the feature is essential. Furthermore, the embodiments given above may be changed as follows.

In the embodiments described above, a configuration is adopted in which, when the control unit performs the switching control, the first control is performed, but there is no limitation to this configuration. For example, a configuration may also be adopted in which the control unit performs second control in which the switching control is performed while the inhibiting unit is kept in the inhibition state. Alternatively, the control unit may also be configured to selectively perform the first control and the second control.

The order of the processing in step S11 and the processing in step S12, in FIG. 2, may be reversed. The order of the processing in step S14 and the processing in step S15, in FIG. 2, may be reversed.

The embodiments disclosed herein are exemplary in all aspects, and thus should not be construed as limiting. The scope of the present disclosure (of the present application) is not limited to the embodiments disclosed herein, and all changes that come within the scope defined by the claims (of the present application) or the meaning and range of equivalency of the claims are intended to be embraced therein.

1. An in-vehicle interrupting current supply device that is applied to an in-vehicle interrupting device including a breaker and a switch, the breaker being provided in an electric power path and including a current input portion that is insulated from the electric power path, and the in-vehicle interrupting device operating to allow current conduction to the current input portion in response to the switch performing an ON operation and thereby cause the breaker to perform an interrupting operation of interrupting the electric power path, the in-vehicle interrupting current supply device comprising:
a transformer that includes a first winding portion and a second winding portion;
a switching unit that switches between an allowance state in which current conduction to the first winding portion is allowed and a cancellation state in which the allowance state is cancelled;
a capacitor that is electrically connected to an intermediate conductive path between the second winding portion and the breaker to receive electric power from the second winding portion,
a discharge circuit that discharges the capacitor through a path that is different from the breaker;
an inhibiting unit that switches between a permission state in which discharging of the capacitor by the discharge circuit is permitted, and an inhibition state in which discharging of the capacitor by the discharge circuit is inhibited; and
a control unit that controls the switching unit and the inhibiting unit,
wherein the control unit performs switching control such that the switching unit repeats alternate switching between the allowance state and the cancellation state,
a charge current is supplied to the capacitor from the second winding portion side in response to the switching control being performed,
a discharge current of the capacitor is supplied to the current input portion in response to the switch performing the ON operation, and
the capacitor is discharged through the path in response to the inhibiting unit switching to the permission state.

2. The in-vehicle interrupting current supply device according to claim 1,
wherein the current input portion includes a first terminal portion and a second terminal portion,
the intermediate conductive path includes a first conductive path provided between one end of the second winding portion and the first terminal portion and a second conductive path provided between the other end of the second winding portion and the second terminal portion,
one electrode of the capacitor is electrically connected to the first conductive path, and the other electrode of the capacitor is electrically connected to the second conductive path,
the discharge circuit includes a resistor connected in parallel to the capacitor between the first conductive path and the second conductive path, and
the inhibiting unit includes a second switch provided between the capacitor and the resistor, switches to the permission state in response to the second switch performing the ON operation, and switches to the inhibition state in response to the second switch performing an OFF operation.

3. The in-vehicle interrupting current supply device according to claim 1, wherein the control unit, after starting the switching control, when the charge voltage of the capacitor has exceeded a threshold voltage, stops the switching control, and switches the inhibiting unit to the inhibition state.

4. The in-vehicle interrupting current supply device according to claim 3, wherein the control unit, after starting the switching control, when the charge voltage of the capacitor has exceeded the threshold voltage, stops the switching control, and, when a predetermined restart condition has been established, restarts the switching control.

5. The in-vehicle interrupting current supply device according to claim 4, wherein the control unit, after stopping the switching control, when the charge voltage of the capacitor has decreased to a second threshold voltage that is smaller than the threshold voltage or less, restarts the switching control.

6. The in-vehicle interrupting current supply device according to claim 4,
wherein the control unit, when a predetermined standby time has elapsed since stopping the switching control, restarts the switching control.

7. The in-vehicle interrupting current supply device according to claim 5, wherein the control unit performs first control in which the switching control is performed while keeping the inhibiting unit in the permission state.

8. The in-vehicle interrupting current supply device according to claim 7, wherein the control unit performs second control in which the switching control is performed while keeping the inhibiting unit in the inhibition state.

9. The in-vehicle interrupting current supply device according to claim 8, wherein the breaker is a pyrotechnic circuit breaker that interrupts the electric power path when a driving current flows into the current input portion.

10. The in-vehicle interrupting current supply device according to claim 1, wherein the control unit, when, after starting the switching control, the charge voltage of the capacitor has exceeded the threshold voltage, stops the switching control, and, when a predetermined restart condition has been established, restarts the switching control.

11. The in-vehicle interrupting current supply device according to claim 1, wherein the control unit performs first control in which the switching control is performed while keeping the inhibiting unit in the permission state.

12. The in-vehicle interrupting current supply device according to claim 1, wherein the control unit performs second control in which the switching control is performed while keeping the inhibiting unit in the inhibition state.

13. The in-vehicle interrupting current supply device according to claim 1, wherein the breaker is a pyrotechnic circuit breaker that interrupts the electric power path when a driving current flows into the current input portion.

14. The in-vehicle interrupting current supply device according to claim 2, wherein the control unit, after starting the switching control, when the charge voltage of the capacitor has exceeded a threshold voltage, stops the switching control, and switches the inhibiting unit to the inhibition state.

15. The in-vehicle interrupting current supply device according to claim 2, wherein the control unit, when, after starting the switching control, the charge voltage of the capacitor has exceeded the threshold voltage, stops the switching control, and, when a predetermined restart condition has been established, restarts the switching control.

16. The in-vehicle interrupting current supply device according to claim 2, wherein the control unit performs first control in which the switching control is performed while keeping the inhibiting unit in the permission state.

17. The in-vehicle interrupting current supply device according to claim 2, wherein the control unit performs second control in which the switching control is performed while keeping the inhibiting unit in the inhibition state.

18. The in-vehicle interrupting current supply device according to claim 2, wherein the breaker is a pyrotechnic circuit breaker that interrupts the electric power path when a driving current flows into the current input portion.
